(19) United States
(12) Patent Application Publication
(10) Pub. No.: US 2002/0177995 A1
(43) Pub. Date: Nov. 28, 2002

(54) Method and arrangement for performing a fourier transformation adapted to the transfer function of human sensory organs as well as a noise reduction facility and a speech recognition facility

(75) Inventor: Michael Walker, Baltmannsweiler (DE)

Correspondence Address: SUGHRUE MION, PLLC, 2100 Pennsylvania Avenue, NW, Washington, DC, 20037-3213, US

(73) Assignee: ALCATEL

(21) Appl. No.: 10/093,035

(22) Filed: Mar. 8, 2002

(30) Foreign Application Priority Data
Mar. 9, 2001 (DE) 101 11 249.1

(51) Int. Cl. G10L 19/14

(52) U.S. Cl. 704/205

(57) ABSTRACT

In the domain of telecommunications, the Fourier Transformation, frequently in the variant Fast Fourier Transformation, or FFT in short, is used, for example, in methods for echo suppression, for noise reduction, for improving speech recognition and for coding audio and video signals. In the case of the FFT, the number of frequencies N and the number of sampling values K are equal, the frequency spacing is constant, the bandwidth is constant, and the delay between the time signal and the frequency spectrum is fixed. These characteristics do not permit adaptation to, for example, psychoacoustic features, the frequency resolution of the human ear being nonlinear. The invention discloses a Continuous Fourier Transformation (CFT), that allows a sliding determination of the fourier transformation instead of former block processing according to the FFT. Further the number of frequency samples and the frequency distribution can be chosen freely and independently from the time sample rate.

### BACKGROUND OF THE INVENTION

The invention is based on a priority application DE 101 11 249, which is hereby incorporated by reference.

The invention concerns a method and an arrangement for performing a Fourier Transformation, which is frequently unavoidable in signal processing for the purpose of analysing and processing the image function of a time signal, the frequency function as well as a method for noise reduction and speech recognition based on said Fourier Transformation method. In the domain of telecommunications, the Fourier Transformation is used in audio and video transmission, for example, in methods for echo suppression, for noise reduction and noise suppression, for improving speech recognition and for coding audio and video signals. Performance of the mathematically fully described Fourier Transformation is only possible in a qualified sense with technical means, only time-discrete sampling values being available in signal processing. The Fourier Transformation can be performed with different numbers of sampling values and pixels, giving rise to the following problems: What is the optimum time resolution? How high must the resolution be in the image domain, in the frequency domain, and what is the most favourable distribution of the pixels?

In the case of a very large number of pixels, it may be that more information is processed than is necessary or than can be perceived by the human sensory organs. The generally known block-wise processing of conventional transformation methods results in a long delay time in the case of a large number of pixels. Since the bandwidths between the pixels are the same over the entire frequency range, the reaction times are slowed unnecessarily for large frequencies. In the case of a small number of pixels, the reaction time may be greater than perceivable, although the resolution may be too low, so that important information is lost.

Generally known is the practice of using the Fast Fourier Transformation, hereinafter referred to as FFT, for signal processing in many products. In comparison with the known Discrete Fourier Transformation, hereinafter referred to as DFT, the FFT has the advantage that the computational requirement is reduced from N*K computational operations to N*ld K computational operations. In the case of the FFT, N discrete frequencies are calculated from K discrete sampling values, according to Equation 1.

$$X ( n ) = \frac{1}{K} {\sum }_{k = 0}^{K - 1} x ( k ) * {ⅇ}^{\frac{- j2π nk}{K}} \qquad ( 1 )$$

K Number of sampling values (time domain) 0≦k<K; kεN

N Number of frequencies (frequency domain) 0≦n<N; nεN

FIG. 1 shows the result of a FFT. Due to the computational method with which the FFT is performed, the frequency range

$$0 < n < \frac{n}{2}$$

is mirrored on the frequency

$$\frac{n}{2} ,$$

so that the frequency range

$$n > \frac{n}{2}$$

can remain disregarded for signal analysis.

Both the DFT and the FFT have the following characteristics:

The number of frequencies N and the number of sampling values K must be equal

Constant frequency spacing

Constant bandwidth

Fixed delay between the time signal and the frequency spectrum

Windowing and an overlap-add function are necessary for back-transformation out of the frequency domain into the time domain by means of the Inverse Fast Fourier Transformation.

Consequently, in the case of the FFT, essential psychoacoustic features are not taken into account. The frequency resolution of the human ear is nonlinear whereas, as to be explained in subsequent observations in the following, the FFT has a linear frequency resolution with equidistant frequency spacings. The time resolution of the human ear is approximately 1.9 ms, but that of a 256 element FFT is, for example, 32 ms. These FFT differences in relation to the psychoacoustic requirements only permit natural-sounding speech transmission with limitations in respect of quality.

Generally known in the art are filter bank solutions by means of which an aurally compensated transformation can be performed. Thus, in this case, for 24 frequency groups, FIR filters with 300 coefficients/frequency group are required for a BARK transformation.

The computational requirement in this case is very large. For example, 60 mega operations per second (MOPS) are required for a sampling rate of 8 kHz and the delay of the time signal in respect of the frequency signal is 18.75 ms.

Although, with a cascade arrangement of sub-band filters, cf. Kapust, R.: Qualitätsbeurteilung codierter Audiosignale mittels einer BARK-Transformation, Dissertation, Technical Faculty of the University of Erlangen-Nürnberg, 1993, page 41, a nonlinear frequency conversion is achieved, the individual frequency groups are nevertheless bound to a fixed division ratio, and an aurally compensated transformation is not achieved.

Another solution approach proceeds from the window length of a FFT, the individual past sampling values being weighted with an exponential function, cf. E. Terhardt: Fourier Transformation of Time Signals: Conceptual Revision, Acustica Vol. 57 (1985), pages 242-256. The coefficients dimensioned for the exponential function are laid on to a relatively large time constant. A critical transient response is exhibited when this solution is implemented.

Finally, there is known in the art the practice of using the Goerzel algorithm for the Fourier Transformation, cf. R. Kapust: loc. cit., pages 57-71. In order to achieve the required different bandwidths of the BARK scale, use is made of polyphase addition on to the input signal blocks with a different but fixed division ratio to the total block length of the signal to be transformed. This, however, involves a very large computational requirement and windowing and an overlap-add function are required for the back-transformation.

### SUMMARY OF THE INVENTION

The object resulting from the known prior art is to disclose a method and an arrangement by which the linear resolution of known transformation methods is replaced by a largely freely definable, non-linear resolution and especially an adaptation to the transmission function of human sensory organs is thereby rendered possible. It is further object of the invention to disclose a noise reduction facility and a speech recognition facility based on said transformation methods.

The essence of the invention consists in that a discrete time signal is transformed into the frequency domain with a selectable distribution of discrete frequencies, resulting in a considerable reduction of calculation effort.

With this, especially the non-linear transmission functions of the human ear and the non-linear transmission functions of the human eye in the signal processing of audio and video signals are taken into account in the transformation of the signals from the time domain into the frequency domain and vice versa.

For the purpose of better describing the essence of the invention, the requirements for an aurally adequate transformation are explained using the example of an acoustic transmission. The invention is not limited to acoustic transmission, however, but is instead applicable in all cases in which a nonlinear transmission behaviour of a system must be processed by a Fourier transformation/back-transformation.

Thus, if an audio signal is to be received in such a way that it sounds natural, it is essential for a series of auditory characteristics to be taken into account in signal processing.

Frequency resolution,

time resolution and

selection characteristics

of the human ear must be taken into account in signal transmission and, for example, in coding procedures, in compression methods, for example, according to the MPEG 3 standard, and in speech recognition. Since the ear, as the message receiver, plays the key role in the transmission media chain, signal processing algorithms must be matched to these auditory characteristics. In comparison with the prior art, the solution according to the invention renders possible a substantially improved simulation of the transformation characteristics of the human ear.

### BRIEF DESCRIPTION OF THE DRAWINGS

In the human ear, a frequency-place transformation takes place, with the anatomy of the ear resulting in a nonlinear frequency resolution. This resolution derives directly from the cochlea of the inner ear. Stimuli within a confined region on the cochlea result in audible masking effects. The range concerned, which undergoes this masking, is termed a frequency group. As shown by FIG. 2, the human ear has 24 frequency groups, which are represented in a BARK scale (BARK named after Heinrich Barkhausen). FIG. 2 shows the frequency perception of the human ear, namely, the critical band rate divided into 24 frequency groups in dependence on the frequency. Clearly identifiable is the flat course in the lower frequency range. A greater frequency resolution is consequently possible for low frequencies. FIG. 3 shows that the bandwidth of the individual frequency groups increases with the frequency.

FIG. 4 shows that the time resolution T of the human ear becomes more sensitive as the bandwidth B increases. It moves close to the Heisenberg limit, which describes the reciprocity of bandwidth B and time resolution T by B*T=0.5, hence

$$T = \frac{0.5}{B} .$$

The mean value is T≈1.9 ms, cf. Kapust: loc. cit. page 52.

FIG. 5 shows the course of the absolute hearing threshold of the human ear in dependence on the frequency. According to this function, a frequency-dependent resolution of the signal level can be weighted. The absolute hearing threshold is lowest in the range between 2000 Hz and 6000 Hz, a fact of which particular account must be taken in the case of noise reduction.

The selection characteristics of the human ear are represented in FIG. 6. Acoustic events within a frequency group result in masking effects. Thus, a narrowband noise, in this case, for example, in the range f≈1000 Hz, masks all lesser signal levels within the frequency group, which is spectrally covered by the noise signal. The absolute hearing threshold is thus influenced by a masker. The listening threshold rise is approximately 100 dB/octave in the lower range, and decreases as the frequency increases.

In the following, the method according to the invention are now described in greater detail.

The condition that, using the well known Fast Fourier Transformation (FFT), the number N of discrete frequencies must equal to number K of discrete sampling values results in fixed bandwidths, from which there result two substantial disadvantages for an aurally compensated transformation:

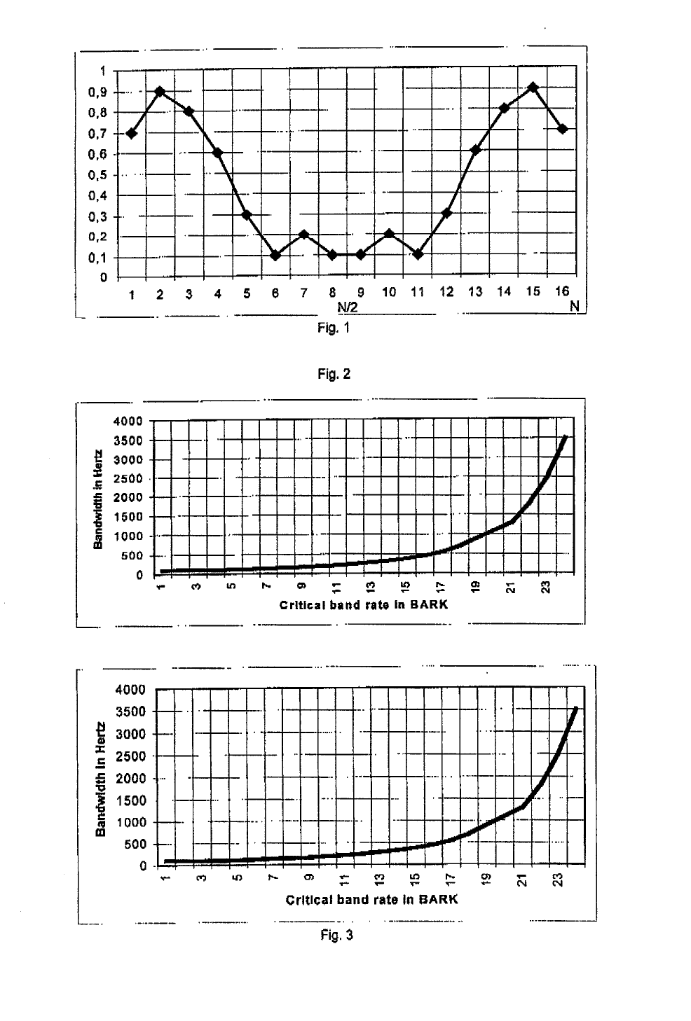

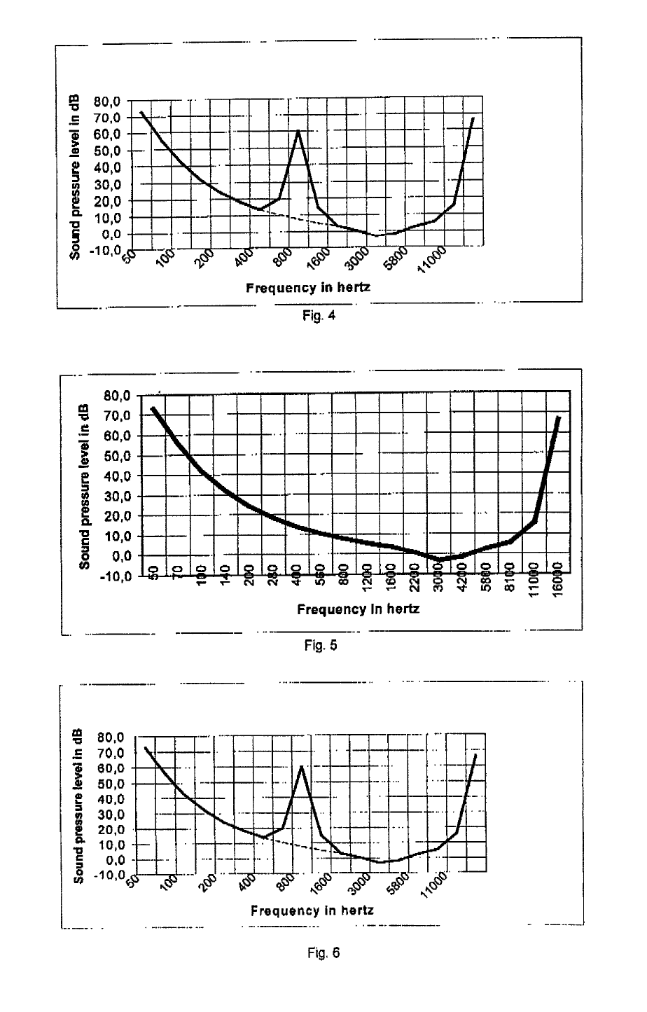

No adaptation to the BARK scale, cf. FIG. 3 and FIG. 4

Very rough time resolution, hence large time constants

If N≠K, the bandwidths would no longer harmonize with the frequency spacings, which could result in either large overlaps or holes in the frequency response.

To eliminate this disadvantage, a time signal can be split into several band pass signals and each of this band pass signals can be transformed independently by a Fourier Transformation. For this purpose, the bandwidths B of the individual frequency groups, cf. FIG. 3, must first be determined in order thereby to define the number of sampling values to be determined for the respective frequency.

$$X ( B , n ) = \frac{1}{KB} {\sum }_{k = 0}^{KB} x ( k ) * {ⅇ}^{\frac{- j2π nk}{KB}} \qquad ( 2 )$$

X(B,n) Block with determined bandwidth B

KB Number of sampling values K (time domain) corresponding to the bandwidth B

kεKB

N Number of frequencies (frequency domain), discretionary

nεN

According to Equation 2, an extra sum must be generated for each bandwidth B to be calculated. As shown by FIG. 3, approximately 11 different bandwidths are given by the BARK scale, account being taken of the fact that the bandwidth is virtually constant in the lower frequency range, up to 12 BARK. With a logarithmic scaling of the frequency scale, each frequency line has a different bandwidth. Since the sums according to Equation 2 are calculated as blocks with a fixed magnitude which is dependent on the bandwidth, N block processing operations are then required to achieve the desired transformation.

According to the invention, an alternative Fourier Transformation method is disclosed, in the following referred to as Continuous Fourier Transformation (CFT) that allows a dissociation from the block processing. The CFT replaces the block processing by a sliding integration. Instead of a block processing described above, a sliding transformation, where new frequency values are determined for each new time is now possible. As integrator, low pass filter LP, preferable recursive low pass filters, are suitable, see Equation 3.

X(n)=LP(x(k)*e^{-j2πnk/K}) (3)

X(n) Frequency line

The integrator must be dimensioned such that the calculated frequency line X(n) to be calculated results essentially in an average of the integrated values. The time constant is thus frequency-dependent, and should be a multiple v of the time constant resulting from the frequency to be calculated.

$$τ \approx v \cdot \frac{1}{2 \cdot π \cdot X ( n )}$$

The integrator is also used to determine the bandwidth B(n) with which a frequency line or a frequency group is transmitted. The bandwidth B(n) of the integrator, to which a frequency line X(n) is assigned, is determined from the frequency spacing of the adjacent frequencies of n, i.e. the frequency distance between the left neighboured frequency line X(n−1) and the right neighboured frequency line X(n+1). Since, in each case, X(n)<B(n), both requirements are fulfilled if the limiting frequency of the low-pass filter LP is determined according to Equation 4.

$$fg = \frac{B ( n )}{2} = \frac{frequency ( X ( n + 1 ) ) - frequency ( X ( n - 1 ) )}{4} \qquad ( 4 )$$

The order of the recursive low-pass filter TP can be freely selected. Experiments have shown that an exact reproduction of the time signal by means of the CFT and Inverse Continuous Fourier Transformation ICFT can be achieved even with first-order low-pass filters.

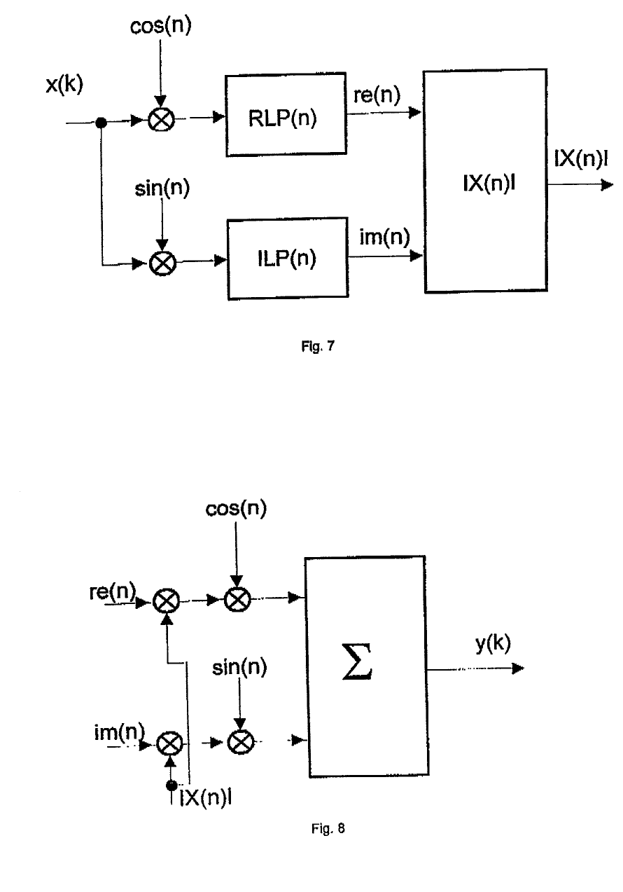

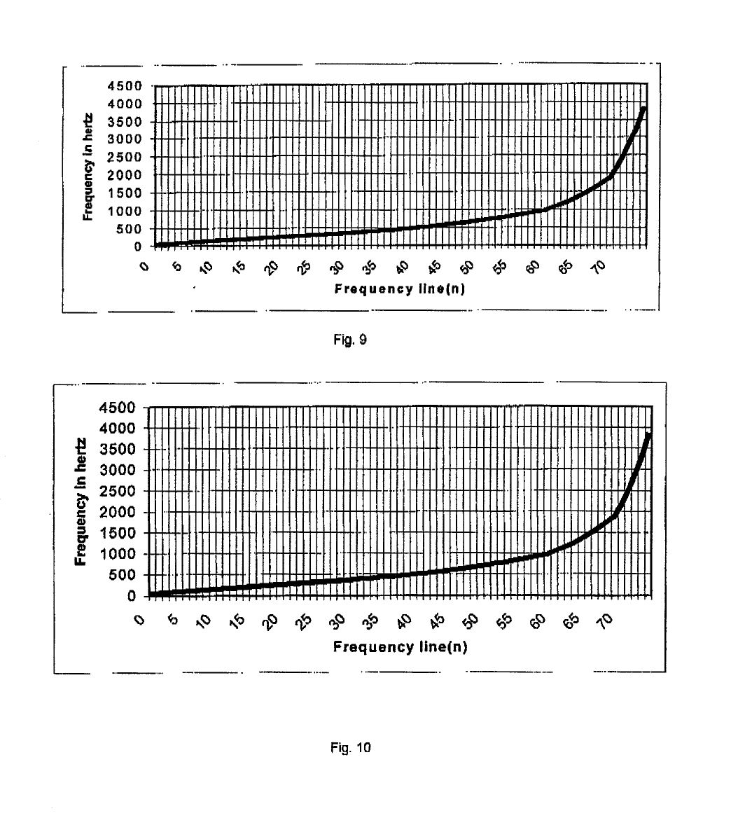

A very good approximation to the course of the absolute hearing threshold of the human ear according to FIG. 5 can be achieved with eighth-order recursive filters.

In the following, by way of example a first order low pass is chosen. The z-transformation of a first order recursive low pass can be presented as follows:

$$H ( z ) = \frac{a}{1 - b \cdot {z}^{- 1}} \qquad ( 5 )$$

In the time domain a corresponding recursive formula can be presented as follows:

$$\begin{matrix}Y ( k ) = a \cdot y ( k ) + b \cdot Y ( k - 1 ) \\ \text{with:} & ( 6 ) \\ b = {ⅇ}^{- ( \frac{2 \cdot π \cdot fg}{Fs} )} = {ⅇ}^{- ( \frac{1}{Fs \cdot τ} )} and a = 1 - b & ( 7 )\end{matrix}$$

with Fs being the sample frequency and fg being the critical frequency of the low pass filter.

With equations (3) and (6), the following equation (8) can be formulated:

$$X ( n , k ) = a ( n ) \cdot ( x ( k ) \cdot {ⅇ}^{- j2 π nk / K } ) + b ( n ) \cdot X ( n , k - 1 ) \qquad ( 8 )$$

and with e^{-j2πnk/K}=cos(2πnk/K)−j sin(2πnk/K):

$$\begin{matrix}\begin{matrix}X ( n , k ) = a ( n ) \cdot ( x ( k ) \cdot cos ( 2 π / K \cdot nk ) - j \cdot x ( k ) \cdot \\ sin ( 2 π / K \cdot nk ) ) + b ( n ) \cdot X ( n , k - 1 )\end{matrix} \\ or \text{:} & ( \text{8a} ) \\ \begin{matrix}X ( n , k ) = a ( n ) \cdot ( x ( k ) \cdot cos ( cnk ) - j \cdot x ( k ) \cdot sin ( cnk ) ) + \\ b ( n ) \cdot X ( n , k - 1 ) ; c = 2 π / K\end{matrix} & ( \text{8b} )\end{matrix}$$

X(n,k) in the previous equations means the Frequency line at the discrete Frequency n at the (sample) time k. Each the real component Re(X(n,k)) and the imaginary component Im(X(n,k)) of the complex frequency line X(n,k) can be determined by separate low pass filters:

$$\begin{matrix}X ( n , k ) = a ( n ) \cdot x ( k ) \cdot cos ( cnk ) + b ( n ) Re ( X ( n , k - 1 ) - j \cdot \\ ( a ( n ) \cdot x ( k ) \cdot sin ( cnk ) + b ( n ) \cdot Im ( X ( n , k - 1 ) ) ) ; \\ c = 2 π / K\end{matrix} \qquad ( \text{8c} )$$

Thus a quasi continuous transformation of the time signal can be carried out. The draw backs of the block processing described above is thus avoided.

The absolute value can be determines as follows:

|X(n,k)|={square root over (((Re(X(n,k))²+(Im(X(n,k))²))} (8d)

The back-transformation is effected according to Equation 9:

$$x ( k ) = {\sum }_{n = 0}^{N - 1} X ( n ) \cdot {ⅇ}^{j2 π nk / N} \qquad ( 9 )$$

The complex frequencies for the CFT and ICFT can either be taken from a table, as is usual, or freely generated by means of a sine tone generator. In this case, an exact phase relation must then be maintained between sine and cosine oscillation. Experiments with free oscillators have shown that any given frequency can be taken into account.

A circuit arrangement for performing the method is represented in FIG. 7 and FIG. 8. For the CFT according to FIG. 7, a discrete sampling value x(k) in the time domain is convolved with the sine sampling value sin(n) and the cosine sampling value cos(n) of the respective frequency line n, in the associated first low-pass filter ILP(n) as an imaginary component and in the second low-pass filter RLP(n) as a real component. Generation of the absolute value from the convolved function re(n) at the output of the second low-pass filter RLP(n) and from the convolved function im(n) at the output of the first low-pass filter ILP(n) is effected according to Equation 7 and is realized by means of, for example, a short average magnitude SAM.

|X(n)|=f(\sqrt{re²(n)+im²(n)}) (11)

FIG. 8 shows the back transformation, further referred to as inverse continuous fourier transformation ICFT of an adapted signal from the frequency domain into the time domain. For all n with 0≦n<N, the real component re(n) and the imaginary component im(n) of the frequency function F(n)=re(n)−j·im(n) of a filter curve for adaptation of the transformed input signal are weighted with the corresponding absolute value |X(n)| and then multiplied with the corresponding cosine sample value cos(cnk) or the sine sample value sin(cnk) respectively. Both results are summed according to Equation 12, and produce the back-transformed signal y(k).

$$\begin{matrix}y ( k ) = {\sum }_{n = 0}^{N - 1} ( \vert X ( n ) \vert re ( n ) cos ( cnk ) + \\ \vert X ( n ) \vert im ( n ) sin ( cnk ) , c = 2 π / N\end{matrix} \qquad ( 12 )$$

FIG. 9 shows an embodiment representing the forward transformation CFT of a time signal x(k) into a frequency signal X(n) and the back-transformation ICFT of a frequency signal X(n) into a time signal y(k). The input signal x(k), by way of example, is divided into four frequency groups, scaled logarithmically. There is formed, at a sampling frequency Fs=8 kHz, a first frequency group with a bandwidth B=500 Hz, at a sampling frequency

$$\frac{1}{8} Fs = 1000 Hz ,$$

a second frequency group with a bandwidth B=1000 Hz, at a sampling frequency

$$\frac{1}{4} Fs = 2000 Hz ,$$

a third frequency group with a bandwidth B=2000 Hz, at a sampling frequency

$$\frac{1}{2} Fs = 4000 Hz ,$$

and a fourth frequency group for frequencies up to 4000 Hz, at a sampling frequency Fs=8000 Hz. Via the bandpass filters BP 500, BP 1000 and BP 2000, and via the high-pass filter HP 2000, the input signal x(k) according to FIG. 9 is transformed by means of the CFT into the frequency domain, in which it is processed according to the application and transformed back into the time domain by means of the ICFT, via low-pass filters LP and interpolation filters IP and through summation.

The computational requirement for the CFT according to FIG. 7 is a total of 17 computational operations for a frequency line, namely, in the case of a first-order filtering, respectively 1 computational operation for the convolution and 3 computational operations for the filtering, such that 8 computational operations are required for the formation of the complex quantities. In addition, 7 computational operations are required for the formation of the averaged absolute value |X(n)| and 2 computational operations for a status query on the rise and fall of the averaged values. Five computational operations are required for the ICFT, namely, respectively one for the convolution, one for the weighting with the absolute value and one for the summation.

Twenty-two computational operations are thus required for the calculation of a frequency line. In the case of a CFT with 75 frequency lines, as represented in FIG. 10, and a sampling frequency of Fs=8 kHz, the total computational requirement CP is thus

$$\begin{matrix}CP = 22 * 75 * 8000 = 13.2 MOPS \\ = 13.2 mega operations per second\end{matrix}$$

FIG. 10 shows the distribution of the frequency lines to the frequency groups, as is particularly advantageous, for example, in the case of an economically optimized version. This distribution is also eminently suitable in the case of the application of a noise reduction in the spectral domain.

The first frequency group up to 500 Hz is allotted 40 frequency lines, the second frequency group up to 1000 Hz is allotted 20 frequency lines, the third frequency group up to 2000 Hz is allotted 10 frequency lines and the fourth frequency group up to 4000 Hz is allotted 5 frequency lines. In the noise reduction example illustrated, a high frequency resolution is desired in precisely that frequency range in which the majority of frequencies which are attributable to the interference source occur, i.e., practically, the range between f=0 and 2 kHz. As shown in FIG. 10, 75 frequency lines have been logarithmically distributed such that the frequency resolution in the lower frequency range up to 500 Hz is particularly high, in this case being 10 Hz. Such a frequency resolution is not even achieved with a FFT with 512 frequency lines, the frequency resolution in this case being 16 Hz. As shown by FIG. 10, the frequency resolution decreases, to the topmost frequency line, to 510 Hz, corresponding to a time resolution of 0.98 ms, whereas the FFT with 512 frequency lines has a constant value of 31.25 ms. The occurrence of musical tones, which occur in the case of the FFT, is thus easily eliminated with the CFT.

The above-mentioned computational requirement can be greatly reduced through subsampling with decimation filters and interpolation filters. The range with the most frequency lines can be subjected to the greatest subsampling. Experiments have shown that the above-mentioned 75 frequency lines per sampling value can be reduced to 20 frequency lines per sampling value without loss of quality. Eighth-order elliptical canonical filters were selected in the experiment. The requirement is 70 computational operations for all filters, the computational requirement in this example being

$$\begin{matrix}CP ( 75 ) = ( 22 * 20 + 70 ) * 8000 \\ = 4.08 MOPS .\end{matrix}$$

No DSP-specific multiplications with additions (MAC) were used in this estimation. Again, in this case, hardware savings can therefore be achieved.

The advantage of a logarithmic frequency division or a frequency division into frequency groups in BARK consists in that relatively more frequency lines are calculated in precisely those frequencies which are highly subsampled and, consequently, substantially fewer frequencies lines need be calculated per sampling value in total. In this respect, the CFT offers all degrees of freedom, depending on the application.

In addition to the aurally compensated transformation in consideration of the BARK scale, the aurally compensated distribution of the frequency lines according to the mel scale is of practical importance, particularly in the case of application of the CFT in combination with a codec. The ratio pitch Hᵥ, as a function of the frequency f, is measured in mel (derived from melody), cf. E. Zwicker; Psychoakustik, Springer Verlag, Berlin, Heidelberg, New York, 1982, pages 57-60. Experiments with the CFT/ICFT have shown that, with exploitation of the auditory masking, an aurally compensated reproduction of the time signal is achieved with as few as 17 frequency lines at a sampling rate of 8 kHz.

The use of the CFT, is particularly advantageous in the case of speech recognition devices. In FIG. 11, by way of example, a block diagram for a speech recognition facility is shown. Whereas, in the case of the FFT, a post-processing of the linearly distributed frequency lines is necessary for preparation of the speech coefficients, this post-processing is not applicable to the CFT since, in the case of the CFT, a distribution of the frequency lines advantageous for the speech recognition facility is produced directly, for example, according to the mel scale. According to FIG. 11, a combined CFT-mel Transformation, referred to in the figure as CFT N*mel, is combined with a noise reduction unit NR, connected behind, to reduce the noise of a speech signal in the frequency domain, by way of example, based on a Wiener filter or a so-called Ephraim/Malah algorithm. In a logarithm device LOG the so-called cepstrum coefficients are calculated. The corresponding signal, back transformed in the time domain by means of a so-called discrete cosinus transformation (DCT) or the inverse continuous fourier transformation ICFT is input to a speech recognition unit.

The continuous fourier transformation CFT can also be used advantageously for other well known speech recognition systems or arrangements differing from the block diagram shown in FIG. 11, as long as a frequency transformation of a speech signal is used within said system or arrangement.

Advantageously, as adaptive multirate codecs, the CFT can be used directly as a coder and the ICFT used directly as a decoder. Due to the large degree of freedom of dimensioning possibilities, the CFT/ICFT can be easily adapted to different bit rates.

As is known, the use of the FFT in noise reduction, with use of a Wiener filter or with application of the algorithm by Ephraim/Malah, cf. Y. Ephraim, D. Malah: “Speech enhancement using a minimum mean-square error short-time spectral amplitude estimator”, IEEE Trans. Acoust. Speech Signal Processing, vol. ASSP32, pages 1109-1121, December 1984, results in interfering so-called musical tones.

FIG. 12, by way of example, shows a noise suppression arrangement making use of the continuous fourier transformation CFT. A speech signal first is transformed by means of the CFT from the time domain into the frequency domain. In the frequency domain, the adaptation of the signal takes place by means of a noise reduction unit NR, that, by way of example, is based on a Wiener filter or on a method according to Ephraim/Malah. After adaptation, the frequency signal is transformed back into the time domain by means of the inverse continuous fourier transformation ICFT.

The occurrence of these unwanted musical tones is prevented by the application of the nonlinear CFT, since the errors produced over a block length in the case of the FFT cannot occur in any case. A further improvement in quality is achieved in that the number of frequency lines selected in the noise range is large, thereby achieving a high resolution of the interference spectrum.

The CFT can thus be advantageously combined with methods for noise reduction, for echo suppression, with compression methods, for example, according to the MPEG3 standard, and used as a coder and decoder, for example, according to the GSM standard. Depending on the transmission function of the systems to be analysed or simulated, the CFT/ICFT can be adapted to the respective requirements, in respect of frequency resolution and time resolution, through selection of the frequency groups and the number of frequency lines.

1. Method for performing a Fourier Transformation which is especially adapted to the transmission function of human sensory organs, by which a time function x(k) is mapped out of the time domain into the frequency domain as a sum of frequency lines X(n) with a defined number of frequency lines and a defined frequency distribution, characterized in, that
the a time signal or time function x(k) is multiplied by a cosine sample value cos(cnk) and sine sample value sin(cnk) of the corresponding frequency n to obtain a first real component and a first imaginary component respectively,
said first real component and said first imaginary component are each filtered independently in a low pass filter with both low pass filters being adapted to the frequency to obtain a second real component and a second imaginary component respectively and
the square root of the sum of each the squared second real component and the second imaginary component is determined to obtain the absolute value |X(n)| of the corresponding frequency line X(n).

2. Method according to claim 1, characterized in, that the low pass filters are adapted to the frequency of the line X(n) in, that said filters shows a critical frequency that equals to one fourth of the frequency distance between the left neighboured frequency line X(n−1) and the right neighboured frequency line X(n+1).

3. Method for performing an inverse fourier transformation corresponding to a fourier transformation according to claim 1, characterized in, that the real component re(n) and the imaginary component im(n) of a filter frequency function are firstly weighted each by the absolute value |X(n)| of the frequency line X(n) of a transformed input time signal x(k) and secondly weighted by a cosine sample value cos(cnk) corresponding to the frequency and a sine sample value sin(cnk) corresponding to the frequency respectively and both double weighted results are summed over all frequencies N to obtain the output time value y(k).

4. Method according to claim 1, characterized in that the time function x(k) is mapped into groups of frequency groups, wherein the number of groups and the bandwidth of each group is selectable and wherein each frequency group shows one or more frequency lines X(n).

5. Method according to claim 1, characterized in that the frequency of frequency lines X(n) within the frequency groups are determined such, that the corresponding frequency resolution and time resolution is adapted to the transfer function of the human ear.

6. Method according to claim 1, characterized in that, for the purpose of adaptation to the time behaviour of the human ear, a filtering of the absolute value |X(n)| of the frequency line X(n) is effected.

7. Method according to claim 4, characterized in that the magnitude of the frequency groups is determined according to the BARK scale.

8. Method according to claim 4, characterized in that the magnitude of the frequency groups is determined according to a logarithmic scale.

9. Method according to claim 4, characterized in that the number of frequency lines is logarithmically scaled from frequency group to frequency group.

10. Method according to claim 4, characterized in that the frequency lines are logarithmically scaled within a frequency group.

11. Method according to claim 4, characterized in that defined frequency groups are formed whose respectively highest frequency determines the sampling rate of the formed frequency group according to the sampling theorem.

12. Method according to claim 4, characterized in that, for the purpose of speech recognition, the magnitude of the frequency groups and the number of frequency lines are adapted to the course of the function mel=g(f).

13. Method according to claim 4, characterized in that, for the purpose of coding and decoding with a codec for an aurally compensated transmission, a distribution of the frequency groups and frequency lines is effected according to the BARK scale or according to the mel scale.

14. Method according to claim 4, characterized in that the distribution of the frequency lines and their combination in groups is adapted to different bit rates in the case of an adaptive multirate codec according to the standards in GSM transmission.

15. Method according to claim 4, characterized in that, in the case of application for noise reduction or for echo suppression or in the case of data compression methods, the distribution of the frequency lines is respectively adapted to the transmission function of the system to be analysed and processed.

16. Arrangement for transforming a time function x(k) out of the time domain into the frequency domain, characterized in that, following the convolution with the cosine and sine sampling values of the frequency line X(n), the time signal (x(k)) is supplied to a filter for the real component and to a filter for the imaginary component and the outputs of the filters are connected to an absolute-value generator |X(n)| from the output of which the absolute value of a frequency line X(n) is provided.

17. Arrangement for transforming the frequency function out of the frequency domain into the time domain, characterized in that, following the weighting of the real component of a filter function with the absolute sample value of the frequency line |X(n)| and with a cosine sample value cos(cnk) and the weighting of the imaginary component of a filter function with the absolute sample value of the frequency line |X(n)| and with a sine sample value sin(cnk), the resulting real component and imaginary component are both supplied to a summing unit summing up each of said real component and imaginary component over all frequencies to obtain an output time value y(k).

18. A facility for noise reduction, comprising a time to frequency transformation unit according to claim 16, a frequency to time transformation according to claim 17 and a noise reduction unit disposed in between said frequency transformation unit and said frequency to time transformation for reducing the noise within the frequency domain of an input signal.

19. A facility for speech recognition, characterized in, that a time to frequency transformation unit according to claim 16 is comprised.
